(19) United States
(12) Patent Application Publication
(10) Pub. No.: US 2017/0132962 A1
(43) Pub. Date: May 11, 2017

(54) TRANSPARENT DISPLAY

(71) Applicant: Wuhan China Star Optoelectronics Technology Co., Ltd., Wuhan (CN)

(72) Inventor: Yuejun TANG, Shenzhen (CN)

(73) Assignee: Wuhan China Star Optoelectronics Technology Co., Ltd., Wuhan (CN)

(21) Appl. No.: 15/011,307

(22) Filed: Jan. 29, 2016

(30) Foreign Application Priority Data
Nov. 9, 2015 (CN) 201510755889.9

(51) Int. Cl. G09G 3/20; G09G 3/32

(52) U.S. Cl. CPC G09G 3/2003; G09G 3/32; G09G 2300/0452

(57) ABSTRACT

The present invention discloses a transparent display, comprising a backlight module, an array substrate, a liquid crystal layer and a color filter substrate which are sequentially stack up in a picture display direction, and the color filter comprises a plurality pixel area which are adjacent, and each of the pixel areas comprises a display area and a transparent area, and the display area comprises a red sub pixel area, a green sub pixel area and a blue sub pixel area, and the transparent area comprises a white sub pixel area, and the array substrate comprises a plurality of thin film transistors aligned in array, and the plurality of thin film transistors correspond to the red sub pixel area, the green sub pixel area, the blue sub pixel area and the white sub pixel area one to one.

### FIELD OF THE INVENTION

The present invention relates to a transparent display technology field, and more particularly to a transparent display.

### BACKGROUND OF THE INVENTION

The transparent display means that the display itself possesses the light penetration of a certain degree, which can allow the user can clearly see the background behind the display as watching the display. Therefore, the transparent display is applied for building widows, car windows or shop windows.

The transparent display according to prior art generally comprises the transparent area and the display area at the same time. When the transparent display shows the image, showing the background picture and the image picture at the same time can be realized. However, the display quality of the image picture in such display mode is worse. For solving the issue of bad display quality of the image picture, a mode of making the transparent area of the transparent display be in the dark state in the mode of achieving the image picture is proposed in the industry, thus the display quality of the image picture can be ensured. However, the new solution brings the new problems: the display area of the present display generally comprises the traditional red (R), green (G), blue (B), three pixel areas. The red (R), green (G), blue (B), three pixel areas are generally realized by coating the corresponding color resist materials at the color filter substrate side. The color resist material has certain color resist. The light becomes weaker after passing through the color resist. Many application products, such the notebook, the digital camera, the cell phone requires higher practical brightness for the clear watch at the outdoor. For reaching the certain display brightness, the brightness of the backlight can be raised. However, the backlight brightness is large, and the power consumption of the display is large, the usage time of the battery will consequently be shortened.

### SUMMARY OF THE INVENTION

An objective of the present invention is to provide a transparent display consuming low power as showing images.

For realizing the aforesaid objective, the technical solution utilized by the embodiments of the present invention is:
providing a transparent display, comprising a backlight module, an array substrate, a liquid crystal layer and a color filter substrate which are sequentially stack up in a picture display direction, and the color filter comprises a plurality pixel area which are adjacent, and each of the pixel areas comprises a display area and a transparent area, and the display area comprises a red sub pixel area, a green sub pixel area and a blue sub pixel area, and the transparent area comprises a white sub pixel area, and the array substrate comprises a plurality of thin film transistors aligned in array, and the plurality of thin film transistors correspond to the red sub pixel area, the green sub pixel area, the blue sub pixel area and the white sub pixel area one to one.

Preferably, the backlight module comprises a light guide plate and a backlight source, and the light guide plate comprises an incident surface and an illuminating surface which are oppositely located and a side incident surface connecting the incident surface and the illuminating surface, and the illuminating surface of the light guide plate faces the array substrate, and the backlight source is adjacent to the side incident surface of the light guide plate.

Preferably, the transparent display further comprises a light valve, and the light valve covers the incident surface of the light guide plate, and the light valve releases or shields light at one side of the light valve away from the light guide plate.

Preferably, the light valve comprises one of polymer dispersed liquid crystal, cholesteric liquid crystal and a color change backplate.

Preferably, a display area of the transparent area is one-sixth to one-half of a display area of the display area in each pixel area.

Preferably, the transparent display further comprises a plurality of control elements, and the plurality of control elements correspondingly control the plurality of thin film transistors one to one.

Preferably, the transparent display further comprises a display control unit to manage a display mode of the transparent display, and the display control unit comprises an image display sub unit, and the image display sub unit is employed to achieve the display mode of a single display image picture of the transparent display, and the image display sub unit transmits a signal to the plurality of control elements to make the red sub pixel area, the green sub pixel area and the blue sub pixel area show colors, and the white sub pixel area appear in a dark state, or to make the red sub pixel area, the green sub pixel area, the blue sub pixel area and the white sub pixel area show colors; and the image display sub unit further transmits a signal to the light valve to control the light valve to shield the light at one side of the light valve away from the light guide plate.

Preferably, the display control unit further comprises an image and background display sub unit, and the image and background display sub unit is employed to achieve the display mode that the transparent display shows an image picture and a background picture at the same time, and the image and background display sub unit transmits a signal to the plurality of control elements to make the red sub pixel area, the green sub pixel area and the blue sub pixel area show colors, and the white sub pixel releases the light illuminated from the illuminating surface of the light guide plate, and the image and background display sub unit further transmits a signal to the plurality of control elements to the light valve to control the light valve to release the light at one side of the light valve away from the light guide plate.

Preferably, the display control unit further comprises a transparent display sub unit, and the transparent display sub unit is employed to achieve a display mode of a single display background image of the transparent display, and the transparent display sub unit transmits a signal to the plurality of control elements to make the red sub pixel area, the green sub pixel area and the blue sub pixel area appear in a dark state, and the while sub pixel area releases the light illuminated from the illuminating surface of the light guide plate, and the transparent display sub unit further transmits a signal to the light valve to control the light valve to release the light at one side of the light valve away from the light guide plate.

Preferably, the display control unit further comprises a judgment sub unit, and the judgment sub unit is employed to achieve a selecting function of the transparent display for the display mode, and the judgment sub unit receives a instruction and selects to run any one of the image display sub unit, the image and background display sub unit and the transparent display sub unit.

Compared with prior art, the present invention possesses benefits below:

In the transparent display of the present invention, the transparent area comprises the white sub pixel area, and the white sub pixel area is the area without color resist. Therefore, the transparent area can perform the transparent display. Namely, it achieves the function of the transparent display showing the display background picture and the image picture at the same time. Meanwhile, the white sub pixel area can construct the RGBW display mode for the single display of image picture with the red sub pixel area, the green sub pixel area and the blue sub pixel area. Then, the transparent display does not show the background image to ensure the display quality of the image picture. Meanwhile, the white display of the white sub pixel area promotes the brightness of the image picture and reduces the power consumption of the transparent display.

Furthermore, each of the white sub pixel area comprises corresponding thin film transistor. Thus, by controlling the voltages or gray scales of the white sub pixel areas of various pixel areas to control the area, dimension and transparency of each transparent area of the background picture display and the image picture display performed by the transparent display.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a front view structure diagram of a transparent display provided by the embodiment of the present invention.

FIG. 2 is a top view structure diagram of a transparent display provided by the embodiment of the present invention.

FIG. 3 is a structure diagram of one pixel area of a transparent display provided by the embodiment of the present invention.

FIG. 4 is a structure diagram of another pixel area of a transparent display provided by the embodiment of the present invention.

### DETAILED DESCRIPTION OF PREFERRED EMBODIMENTS

For better explaining the technical solution and the effect of the present invention, the present invention will be further described in detail with the accompanying drawings in the specific embodiments.

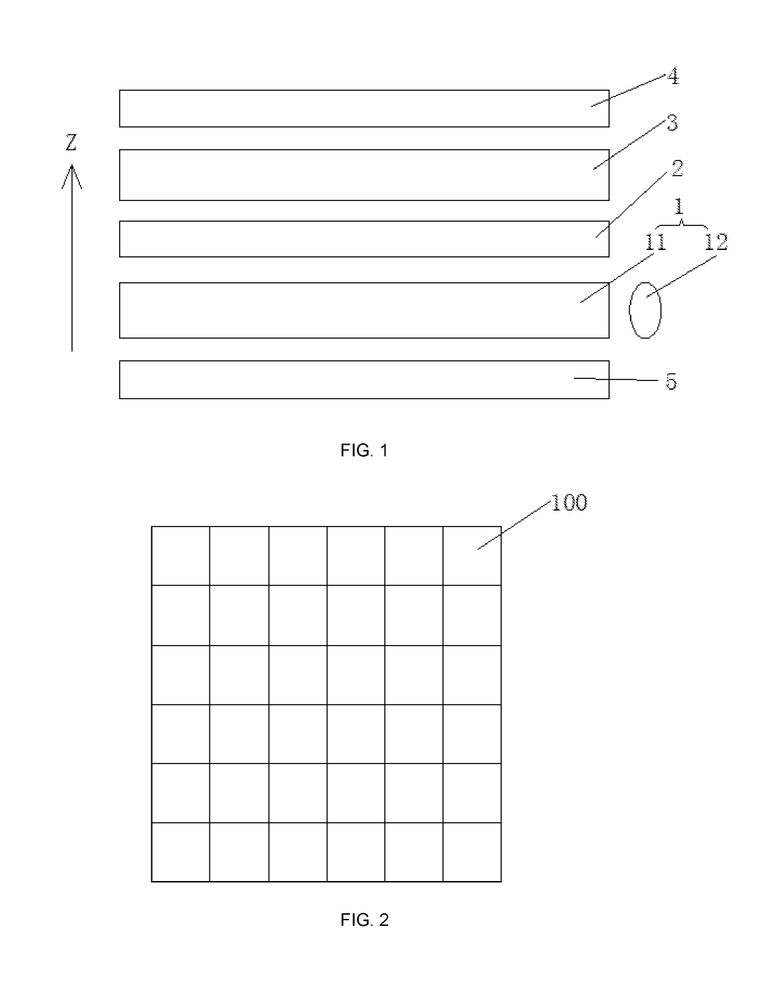

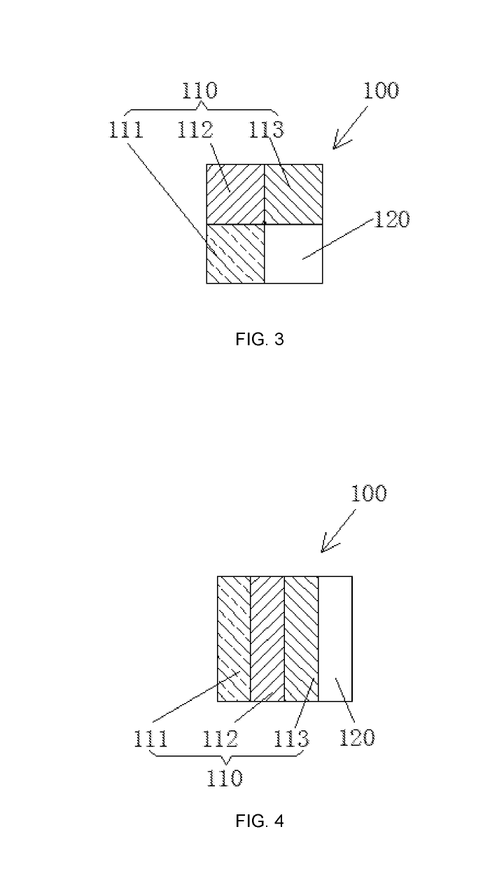

Please refer from FIG. 1 to FIG. 3. The embodiment of the present invention provides a transparent display comprising a backlight module 1, an array substrate 2, a liquid crystal layer 3 and a color filter substrate 4 which are sequentially stack up in a picture display direction Z (the Z direction shown in FIG. 1). As shown in FIG. 2, the color filter comprises a plurality pixel area 100 which are adjacent. As shown in FIG. 3, each of the pixel areas 100 comprises a display area 110 and a transparent area 120, and the display area 110 comprises a red (R) sub pixel area 111, a green (G) sub pixel area 112 and a blue (B) sub pixel area 113, and each of the transparent area 120 comprises a white (W) sub pixel area. The array substrate 2 comprises a plurality of thin film transistors (not shown) aligned in array, and the plurality of thin film transistors correspond to the red sub pixel area 111, the green sub pixel area 112, the blue sub pixel area 113 and the white sub pixel area of the color filter 3 one to one.

In this embodiment, the transparent area 120 in the transparent display comprises the white (W) sub pixel area, and the white (W) sub pixel area is the area without color resist or the white color resist area. Therefore, the transparent area 120 can perform the transparent display. Namely, it achieves the function of the transparent display showing the display background picture and the image picture at the same time. Meanwhile, the white (W) sub pixel area can construct the RGBW display mode for the single display of image picture with the red (R) sub pixel area 111, the green (G) sub pixel area 112 and the blue (B) sub pixel area 113. Then, the transparent display does not show the background image to ensure the display quality of the image picture. Meanwhile, the white (W) display of the white sub pixel area promote the brightness of the image picture and reduces the power consumption of the transparent display.

Furthermore, each of the white (W) sub pixel area comprises corresponding thin film transistor. Thus, by controlling the voltages or gray scales of the white (W) sub pixel areas of various pixel areas 100 to control the area, dimension and transparency of each transparent area 120 of the background picture display and the image picture display performed by the transparent display.

It is understandable that in the embodiment, the location relationship of the display area 110 and the transparent 120 in the pixel area 100 of the transparent display can be arranged to be a matts shape shown in FIG. 3, or can be a structure of a line side by side as shown in FIG. 4. Certainly, the structure of the pixel area 100 according to the present invention is not restricted to the types in the aforesaid embodiments. Without departing from the spirit or essential characteristics of the present invention, the solutions of the present invention achieved in other specific or similar forms should be within the protected scope of the present invention.

As being the preferred embodiment of the present invention, as shown in FIG. 1, the backlight module 1 of the transparent display comprises a light guide plate 11 and a backlight source 12, and the light guide plate 11 comprises an incident surface and an illuminating surface which are oppositely located and a side incident surface connecting the incident surface and the illuminating surface, and the illuminating surface of the light guide plate 11 faces the array substrate 2, and the backlight source 12 is adjacent to the side incident surface of the light guide plate 11.

Moreover, the transparent display further comprises a light valve 5 located adjacent to the incident surface of the light guide plate 11, and the light valve 5 covers the incident surface of the light guide plate 11, and the light valve 5 releases or shields light at one side of the light valve 5 away from the light guide plate 11. When the light valve 5 releases the light at one side of the light valve 5 away from the light guide plate 11, which means allowing the light enter the light guide plate 11, the light valve 5 let the light passing through; when the light valve 5 shields the light at one side of the light valve 5 away from the light guide plate 11, which means not allowing the light enter the light guide plate 11, the light valve 5 reflect or absorb the light. It is understandable that when the white (W) sub pixel performs transparent display, the light valve 5 is controlled to release the light at one side of the light valve 5 away from the light guide plate 11, which means that the background picture light enters the incident surface of the light guide plate 11, and the transparent display shows the display background picture and the image picture at the same time; when the white (W) sub pixel is employed to be the display sub pixel in the RGBW display mode, the light valve 5 can be controlled to shield the background picture light to prevent the background picture light entering the incident surface of the light guide plate to influence the display quality of the image picture. The transparent display shows the image picture with high quality.

Furthermore, the light valve 5 comprises polymer dispersed liquid crystal or cholesteric liquid crystal. Both the polymer dispersed liquid crystal and cholesteric liquid crystal can appear in transparent and opaque, two states.

It is understandable that the light valve also can comprise a color change backplate. The color change backplate utilizes any one of electrochromic material, photochromic material and thermochromic material. The color change backplate can appear in transparent and opaque, two states.

Certainly, the material of the light valve 5 according to the present invention is not restricted to the types in the aforesaid embodiments. Without departing from the spirit or essential characteristics of the present invention, the solutions of the present invention achieved in other specific or similar forms should be within the protected scope of the present invention.

Furthermore, a display area of the transparent area 120 is one-sixth to one-half, and preferably one-third of a display area of the display area 110 in each pixel area of the transparent. The size of the transparent area 120 influences the transparency of the transparent display. By locating the transparent area with larger display area, the transparency of the transparent display can be raised.

As being the preferred embodiment of the present invention, the transparent display further comprises a plurality of control elements, and the plurality of control elements correspondingly control the plurality of thin film transistors one to one.

In this embodiment, the transparent display can further comprise a display control unit to manage a display mode of the transparent display. The display control unit comprises an image display sub unit, and the image display sub unit is employed to achieve the display mode of a single display image picture of the transparent display. When the image display sub unit runs, the image display sub unit transmits a signal to the plurality of control elements to make the red sub pixel area, the green sub pixel area and the blue sub pixel area show colors, and the white sub pixel area appear in a dark state, or to make the red sub pixel area, the green sub pixel area, the blue sub pixel area and the white sub pixel area show colors for showing the image picture; and the image display sub unit further transmits a signal to the light valve to control the light valve to shield the light at one side of the light valve away from the light guide plate.

Moreover, the display control unit further comprises an image and background display sub unit, and the image and background display sub unit is employed to achieve the display mode that the transparent display shows an image picture and a background picture at the same time. When the image and background display sub unit runs, the image and background display sub unit transmits a signal to the plurality of control elements to make the red sub pixel area, the green sub pixel area and the blue sub pixel area show colors for showing the image picture; meanwhile, the white sub pixel releases the light illuminated from the illuminating surface of the light guide plate for showing the background picture, and the image and background display sub unit further transmits a signal to the plurality of control elements to the light valve to control the light valve to release the light at one side of the light valve away from the light guide plate for regulating the light intensity passing through the white sub pixel area.

Moreover, the display control unit further comprises a transparent display sub unit, and the transparent display sub unit is employed to achieve a display mode of a single display background image of the transparent display. When the transparent display sub unit runs, the transparent display sub unit transmits a signal to the plurality of control elements to make the red sub pixel area, the green sub pixel area and the blue sub pixel area appear in a dark state for not showing the image picture; meanwhile, the while sub pixel area releases the light illuminated from the illuminating surface of the light guide plate to show the background picture, and the transparent display sub unit further transmits a signal to the light valve to control the light valve to release the light at one side of the light valve away from the light guide plate.

Furthermore, the display control unit further comprises a judgment sub unit, and the judgment sub unit is employed to achieve a selecting function of the transparent display for the display mode, and the judgment sub unit receives a instruction and selects to run any one of the image display sub unit, the image and background display sub unit and the transparent display sub unit.

It should be understood that the transparent display of the present invention can selectively comprises any one or more of the image display sub unit, the image and background display sub unit and the transparent display sub unit. Namely, the transparent display can have one or more display modes, which can comprises other display modes. Without departing from the spirit or essential characteristics of the present invention, the solutions of the present invention achieved in other specific or similar forms should be within the protected scope of the present invention. Preferably, the transparent display has a plurality of display modes. Then, the display control unit comprises the judgment sub unit for assisting the selection and switch of the display modes.

The judgment sub unit of the aforesaid display control unit can run any one or more of the image display sub unit, the image and background display sub unit and the transparent display sub unit according to the instruction inputted by the user. Thus, the white sub pixel area can be the white sub pixel in the RGBW for display to have the merit of low power consumption, and also can be the transparent pixel area of the transparent area for showing the background picture. With combining the application of the light valve 5, the display quality of the display image can be promoted in advance. The function principle of the light valve 5 in the aforesaid display sub unit has already been described as aforementioned. The repeated description is omitted here.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A transparent display, comprising a backlight module, an array substrate, a liquid crystal layer and a color filter substrate which are sequentially stack up in a picture display direction, and the color filter comprises a plurality pixel area which are adjacent, and each of the pixel areas comprises a display area and a transparent area, and the display area comprises a red sub pixel area, a green sub pixel area and a blue sub pixel area, and the transparent area comprises a white sub pixel area, and the array substrate comprises a plurality of thin film transistors aligned in array, and the plurality of thin film transistors correspond to the red sub pixel area, the green sub pixel area, the blue sub pixel area and the white sub pixel area one to one.

2. The transparent display according to claim 1, wherein the backlight module comprises a light guide plate and a backlight source, and the light guide plate comprises an incident surface and an illuminating surface which are oppositely located and a side incident surface connecting the incident surface and the illuminating surface, and the illuminating surface of the light guide plate faces the array substrate, and the backlight source is adjacent to the side incident surface of the light guide plate.

3. The transparent display according to claim 2, wherein the transparent display further comprises a light valve, and the light valve covers the incident surface of the light guide plate, and the light valve releases or shields light at one side of the light valve away from the light guide plate.

4. The transparent display according to claim 3, wherein the light valve comprises one of polymer dispersed liquid crystal, cholesteric liquid crystal and a color change backplate.

5. The transparent display according to claim 1, wherein a display area of the transparent area is one-sixth to one-half of a display area of the display area in each pixel area.

6. The transparent display according to claim 3, wherein the transparent display further comprises a plurality of control elements, and the plurality of control elements correspondingly control the plurality of thin film transistors one to one.

7. The transparent display according to claim 6, wherein the transparent display further comprises a display control unit to manage a display mode of the transparent display, and the display control unit comprises an image display sub unit, and the image display sub unit is employed to achieve the display mode of a single display image picture of the transparent display, and the image display sub unit transmits a signal to the plurality of control elements to make the red sub pixel area, the green sub pixel area and the blue sub pixel area show colors, and the white sub pixel area appear in a dark state, or to make the red sub pixel area, the green sub pixel area, the blue sub pixel area and the white sub pixel area show colors; and the image display sub unit further transmits a signal to the light valve to control the light valve to shield the light at one side of the light valve away from the light guide plate.

8. The transparent display according to claim 7, wherein the display control unit further comprises an image and background display sub unit, and the image and background display sub unit is employed to achieve the display mode that the transparent display shows an image picture and a background picture at the same time, and the image and background display sub unit transmits a signal to the plurality of control elements to make the red sub pixel area, the green sub pixel area and the blue sub pixel area show colors, and the white sub pixel releases the light illuminated from the illuminating surface of the light guide plate, and the image and background display sub unit further transmits a signal to the plurality of control elements to the light valve to control the light valve to release the light at one side of the light valve away from the light guide plate.

9. The transparent display according to claim 8, wherein the display control unit further comprises a transparent display sub unit, and the transparent display sub unit is employed to achieve a display mode of a single display background image of the transparent display, and the transparent display sub unit transmits a signal to the plurality of control elements to make the red sub pixel area, the green sub pixel area and the blue sub pixel area appear in a dark state, and the while sub pixel area releases the light illuminated from the illuminating surface of the light guide plate, and the transparent display sub unit further transmits a signal to the light valve to control the light valve to release the light at one side of the light valve away from the light guide plate.

10. The transparent display according to claim 9, wherein the display control unit further comprises a judgment sub unit, and the judgment sub unit is employed to achieve a selecting function of the transparent display for the display mode, and the judgment sub unit receives a instruction and selects to run any one of the image display sub unit, the image and background display sub unit and the transparent display sub unit.
